(19) United States
(12) Patent Application Publication
(10) Pub. No.: US 2019/0240682 A1
(43) Pub. Date: Aug. 8, 2019

(54) Shower Device Without Remaining Water

(71) Applicant: Sinyu Technology (Fujian) Co., Ltd., Zhangzhou (CN)

(72) Inventor: Zhangjun Yu, Zhangzhou (CN)

(21) Appl. No.: 16/340,957

(22) PCT Filed: Aug. 19, 2016
(86) PCT No.: PCT/CN2016/095958

§ 371 Date: Apr. 10, 2019

(30) Foreign Application Priority Data
Jul. 26, 2016 (CN) CN20162079234.6

(51) Int. Cl. B05B 1/18; B05B 1/30

(52) U.S. Cl. CPC B05B 1/18; B05B 1/30

(57) ABSTRACT

Disclosed is a shower device without remaining water, including a body and a connector. A water division body and a water outlet body are arranged successively from top to bottom within the body, and an elastic seal pad is provided there between. The water outlet body is provided with a water outlet passage, a water division post is arranged in an inner axial hole of the water division body, and a water inlet hole is formed between an outer side wall of the water division post and an inner wall of the inner axial hole of the water division body. The water division post is provided with a drain passage, with a water inlet end of the drain passage extending to a lower end surface of the water division post, and a water outlet end of the drain passage extending to a side wall of the water outlet body.

### CROSS-REFERENCE TO RELATED APPLICATIONS

The present application claims priority to Chinese Patent Application No. 201620792346.4, entitled “Shower Device Without Remaining Water” and filed on Jul. 26, 2016 with the Chinese Patent Office, the entire contents of which are hereby incorporated by reference.

### TECHNICAL FIELD

The present disclosure relates to the technical field of sanitary ware, in particular, to a structure of a shower device without residual water (remaining water).

### BACKGROUND

For a common bar-type shower device, when a faucet (shower head) thereof is turned off and water is stopped, water in the shower device cannot be discharged (drained), whose longtime retention inside a pipe of the shower device will lead to breeding of bacteria and is apt to cause rusting of a steel pipe, moreover, when hot water is turned on for taking a hot shower, it requires to first discharge cold water remaining in the pipe then hot water can flow out, which affects consumer's using experience.

### SUMMARY

In order to solve the above technical problems, an object of the present disclosure is to provide a structure of a shower device without residual water with simple structure, reasonable design, and reliable performance.

In order to realize the above object, the present disclosure adopts a technical solution as follows:

A structure of a shower device without residual water, which is connected at a water outlet of an upper end of a faucet, wherein the structure of the shower device includes a body and a connector, a lower end of the body is connected with the connector to form one piece; a water division body and a water outlet body are arranged successively from top to bottom within the body, and an elastic seal gasket (pad) is provided between the water division body and the water outlet body; the water outlet body is provided with a water outlet passage passing through the water outlet body in an axial direction, a water division post is arranged in an inner axial hole of the water division body, a water inlet hole is formed between an outer side wall of the water division post and an inner wall of the inner axial hole of the water division body, and the water division post is provided with a water discharge passage, with a water inlet end of the water discharge passage extending to a lower end surface of the water division post, a water outlet end of the water discharge passage extending to a side wall of the water outlet body, and a water exit corresponding to the water outlet end of the water discharge passage is provided on a side wall of the body; a lower end surface of the elastic seal gasket is in the middle, provided with a downwardly protruding part, an upper end surface of the elastic seal gasket is in the middle, provided with an upwardly protruding part, and a plurality of water outlet holes are provided on the elastic seal gasket and in the periphery of the downwardly protruding part; when the faucet is turned off to stop the water, the downwardly protruding part of the elastic seal gasket blocks the water outlet passage; and when the water flows out from the faucet, the middle of the elastic seal gasket is elastically deformed upward, and the upwardly protruding part blocks the water inlet end of the water discharge passage.

A surface of each of the downwardly protruding part and the upwardly protruding part is a spherical surface.

An overlap part is provided on an outer edge of the elastic seal gasket, wherein the overlap part is provided in an engaging groove formed between the water division body and the water outlet body.

The lower end of the body is in threaded connection with the connector.

With the above technical solution adopted in the present disclosure, water path switching between a normal water outflowing state and a residual water discharging state is accomplished via the elastic deformation of the elastic seal gasket under the action of water pressure, so as to achieve the goal of controlling opening/closing of the water discharge passage, with a simple structure and effective discharge of residual water in the pipe, thus solving problems that longtime existence of residual water inside the pipe causes breeding of bacteria in the pipe, the steel pipe is apt to rust, and only after cold water in the pipe is discharged can hot water flow out when taking a hot shower, etc.

### BRIEF DESCRIPTION OF DRAWINGS

The present disclosure is further described below in detail in connection with accompanying drawings and detailed embodiments.

FIG. 1 is a cutaway view of a device according to the present disclosure, in which residual water in a pipe is fully discharged after water is turned off;

FIG. 2 is a structural schematic view of a water division body; and

FIG. 3 is a structural schematic view of an elastic seal gasket.

### DETAILED DESCRIPTION OF THE INVENTION

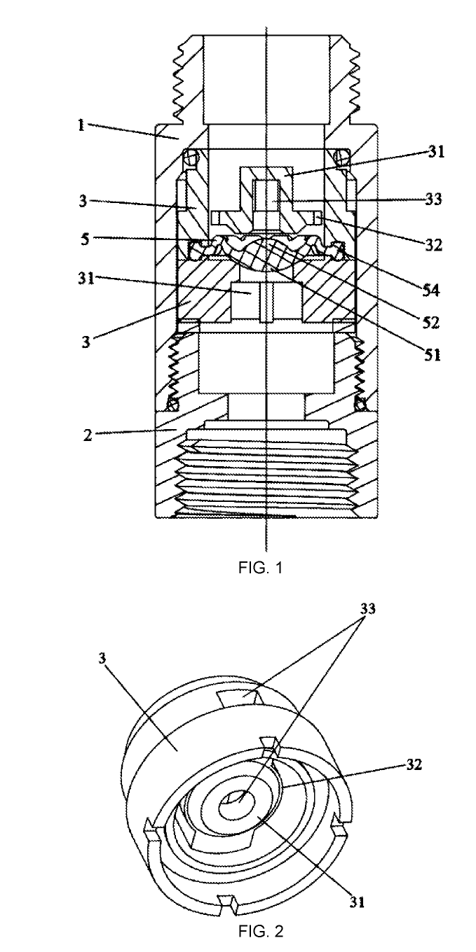

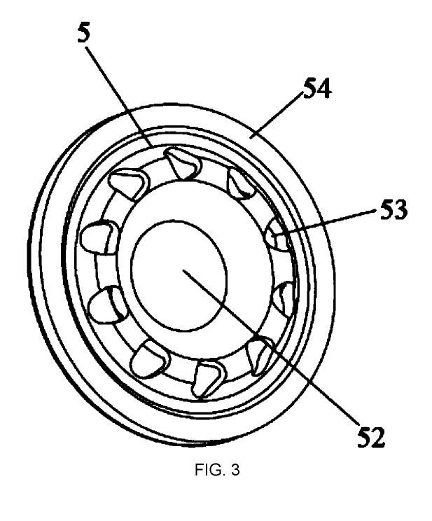

As illustrated in any one of FIG. 1 to FIG. 3, the present disclosure provides a structure of a shower device without residual water, which is connected at a water outlet of an upper end of a faucet, wherein the structure of the shower device includes a body 1 and a connector 2, a lower end of the body 1 is connected with the connector 2 to form one piece; a water division body 3 and a water outlet body 4 are arranged successively from top to bottom within the body 1, and an elastic seal gasket 5 is provided between the water division body 3 and the water outlet body 4; the water outlet body 4 is provided with a water outlet passage 41 passing through the water outlet body in an axial direction, a water division post 31 is arranged in an inner axial hole of the water division body 3, a water inlet hole 32 is formed between an outer side wall of the water division post 31 and an inner wall of the inner axial hole of the water division body 3, and the water division post 31 is provided with a water discharge passage 33, with a water inlet end of the water discharge passage 33 extending to a lower end surface of the water division post 31, and a water outlet end of the water discharge passage 33 extending to a side wall of the water outlet body 4, and a water exit corresponding to the water outlet end of the water discharge passage 33 is provided on a side wall of the body 1; a lower end surface of the elastic seal gasket 5 is in the middle, provided with a downwardly protruding part 51, an upper end surface of the elastic seal gasket 5 is in the middle, provided with an upwardly protruding part 52, and a plurality of water outlet holes 53 are provided on the elastic seal gasket 5 and in the periphery of the downwardly protruding part 51. When the faucet is turned off to stop the water, the downwardly protruding part 51 of the elastic seal gasket 5 blocks the water outlet passage 41; and when the water flows out from the faucet, the middle of the elastic seal gasket 5 is elastically deformed upward, and the upwardly protruding part 52 blocks the water inlet end of the water discharge passage 33.

A surface of each of the downwardly protruding part 51 and the upwardly protruding part 52 is a spherical surface. By using a structure with the spherical surface, the blocking function of the downwardly protruding part and the upwardly protruding part can be effectively improved, thereby improving the reliability of water path switching.

An overlap part 54 is provided on an outer edge of the elastic seal gasket 5, wherein the overlap part 54 is provided in an engaging groove formed between the water division body 3 and the water outlet body 4. Such structure can enable the connection between the elastic seal gasket 5 and the water division body 3 as well as the water outlet body 4 to be more firm, resulting in an optimized sealing performance.

The lower end of the body 1 is in threaded connection with the connector 2. The threaded connection facilitates the disassembly and assembly between the body 1 and the connector 2.

Operating principle of the present disclosure:

When water normally flows out from the faucet, the water flows in from bottom to top. Under the action of water pressure, the middle of the elastic seal gasket 5 is elastically deformed upward, the upwardly protruding part 52 blocks the water inlet end of the water discharge passage 33 such that the water discharge passage 33 is closed, then the water flow enters upward into the pipe after flowing successively through the water outlet holes 53 on the elastic seal gasket 5 and the water inlet hole 32 between the outer side wall of the water division post 31 and the inner wall of the inner axial hole of the water division body 3.

When the faucet is turned off to stop the water, the residual water in the pipe flows downward due to gravity, the elastic seal gasket 5 is no longer under the action of the pressure of the water flow below it, thus the elastic seal gasket 5 returns to an initial state thereof. The downwardly protruding part 51 of the elastic seal gasket 5 blocks the water outlet passage 41, while the water discharge passage 33 is opened, then the residual water flows out through the water discharge passage 33.

What is claimed is:

1. A structure of a shower device without residual water, connected at a water outlet of an upper end of a faucet, wherein the structure of the shower device comprises a body and a connector, a lower end of the body is connected with the connector to form one piece;
a water division body and a water outlet body are arranged successively from top to bottom within the body, and an elastic seal gasket is provided between the water division body and the water outlet body;
the water outlet body is provided with a water outlet passage passing through the water outlet body in an axial direction, a water division post is arranged in an inner axial hole of the water division body, a water inlet hole is formed between an outer side wall of the water division post and an inner wall of the inner axial hole of the water division body, and the water division post is provided with a water discharge passage, with a water inlet end of the water discharge passage extending to a lower end surface of the water division post, and a water outlet end of the water discharge passage extending to a side wall of the water outlet body, and a water exit corresponding to the water outlet end of the water discharge passage is provided on a side wall of the body;
a lower end surface of the elastic seal gasket is, in the middle, provided with a downwardly protruding part, an upper end surface of the elastic seal gasket is, in the middle, provided with an upwardly protruding part, and a plurality of water outlet holes are provided on the elastic seal gasket, in a periphery of the downwardly protruding part;
when the faucet is turned off to stop water, the downwardly protruding part of the elastic seal gasket blocks the water outlet passage; and
when water flows out from the faucet, the middle of the elastic seal gasket is elastically deformed upward, and the upwardly protruding part blocks the water inlet end of the water discharge passage.

2. The structure of the shower device without residual water according to claim 1, wherein a surface of each of the downwardly protruding part and the upwardly protruding part is a spherical surface.

3. The structure of the shower device without residual water according to claim 1, wherein an overlap part is provided on an outer edge of the elastic seal gasket, and the overlap part is provided in an engaging groove formed between the water division body and the water outlet body.

4. The structure of the shower device without residual water according to claim 1, wherein the lower end of the body is in threaded connection with the connector.
